(19) United States
(12) Patent Application Publication
(10) Pub. No.: US 2005/0197725 A1
(43) Pub. Date: Sep. 8, 2005

(54) Music management system

(75) Inventors: Jim Alexander, Oak Park, CA (US); Kelly Gamble, Oak Park, CA (US); Mike Weaver, Oak Park, CA (US); Doron Ben-Zvy, Oak Park, CA (US)

Correspondence Address: CROCKETT & CROCKETT, 24012 CALLE DE LA PLATA, SUITE 400, LAGUNA HILLS, CA, 92653, US

(73) Assignee: Qsonix

(21) Appl. No.: 11/060,894

(22) Filed: Feb. 18, 2005

Related U.S. Application Data
(60) Provisional application No. 60/546,414, filed on Feb. 20, 2004.

(51) Int. Cl. G06F 17/00; A63H 5/00; G10H 7/00; G04B 13/00

(52) U.S. Cl. 700/94

(57) ABSTRACT

A digital music system according to the present disclosure is a single processor system with a drag and drop interface that permits different digital content to be performed simultaneously in two or more performance zones. The user interface may be further optimized for use with a touchscreen display. Each performance zone may have a performance queue independent of other performance zones. Performance queues may be altered at any time during a performance. Transition between each item of digital content in a performance queue is accomplished using a crossfade with user-defined parameters. Additionally, a user in either performance zone may identify a digital content item for preview and the preview may be accomplished while the music management system is performing digital content in the two or more zones.

This application claims priority of copending Unites States provisional patent application 60/546,414 filed Feb. 20, 2004.

### FIELD OF THE INVENTIONS

The present disclosure relates the field of entertainment content management, and more specifically to the field of digital content presentation and management.

### BACKGROUND OF THE INVENTIONS

The music industry is currently undergoing a radical change in the way that music is marketed and delivered to consumers. Record companies are struggling to create and market new artists while consumers are seeking new ways of obtaining the music they want to listen to. The recent trends in online music downloads are the first sign of the coming change in the music distribution industry. While the record industry has shown flattened sales figures over the past couple of years, the early entries into the legitimate pay-per-download models for downloadable music have shown promise and Forrester Research reports that Internet subscriptions and downloads will account for one-third of all music sales by 2008.

The history of digital music can be broken into three stages. In the first stage, PC “techies” showed how the Internet and hard disk storage could handle music better than a massive CD changer unit. Napster and WinAmp caused waves in the music industry, raising questions about the rights to copy and distribute. The second stage consisted of some manufacturers moving the hard disk into their music systems and introduced the formal acceptance of portable digital audio systems by most of the major entertainment system manufacturers. To help the consumer use their systems, software was introduced, primarily Microsoft's Media Center. While attractive to the user, Media Center is slow, primarily “switch” oriented and had a limit on the quantity of music it could handle. The third stage has been the introduction of dedicated digital entertainment systems, some with their own user interface (Escient, Request, iMerge). These systems could handle large quantities of music and could link to other entertainment components. However, the user interfaces remained limited, building off of video menu structures or remaining with Media Center. Additionally, their cost was very high, running in the $3,000-$10,0000 per unit range.

The emergence of high-capacity, low cost storage solutions enabled this revolution in the way that music is stored and played back. Traditional compact disc solutions will continue to transition to modern solutions, such as hard disk and flash-memory-based devices that offer instant, random access to a large library of music in an extremely compact footprint. While this technology has existed for some time, it is only recently that it is beginning to reach wide acceptance, due in part to the recent hardware advances and price point reductions.

Hard-disk based music playback systems have been available for several years, however only since the cost of hard disks of adequate size to hold a typical users' music library have become available at a reasonable price point have these options been possible for the average consumer. Several companies have entered this space and have seen some initial success, however, none have focused specifically on making a device that is focused on a user experience, that includes ease of use, collection of data and that is packaged and priced for wide acceptance.

These advances have also impacted the way music is being distributed. The model for music distribution remained consistent for over 50 years, as artists produced “albums” of 10-15 songs and these were marketed through retail outlets. With the advent of digital delivery of music, it is no longer necessary for an artist to “pad” an album with 8 “filler” songs and 2 hits. It will now be possible for artists to have 2 hit songs that are released standalone. In addition, consumer demand is going away from the desire to purchase an $18 CD containing two songs they want to hear and 8 they do not. The digital distribution of music solves these issues but the music industry leaders must and will undertake significant changes to accommodate these market demands.

This technology change does provide the music industry with some unique opportunities. For example, the average consumer today is exposed to a fairly limited array of new music and this poses not only a problem for the consumer but for the music industry as well. The music industry is beginning to recognize that through the use of digital networks data collection, there are opportunities to track music use, identify buyer attributes, introduce a wide variety of new music, market it directly to interested buyers and sell the music on-line.

The primary driver of this trend is in portable digital systems. This product, more than the PC, helped digital music cross the technology “chasm” and caught the interest of consumers other than the technology experts who had focused on PCs as the digital music system. The technology is now in place, the volumes are increasing, and digital music is going up the steep part of the product life cycle curve. The next wave of music consumers will be seeking additional features, lower prices and simplicity in operating the technology. The result will be a need for new methods of music acquisition, storage organization and playback software.

What is needed are methods and apparatus that allow consumers to play and browse music both already in their collection as well as newly available music for purchase and download in a seamless fashion.

### SUMMARY

A digital music system according to the present disclosure is a single processor system with a drag and drop interface that permits different digital content to be performed simultaneously in two or more performance zones. The user interface may be further optimized for use with a touchscreen display. Each performance zone may have a performance queue independent of other performance zones. Performance queues may be altered at any time during a performance. Transition between each item of digital content in a performance queue is accomplished using a crossfade with user-defined parameters. Additionally, a user in either performance zone may identify a digital content item for preview and the preview may be accomplished while the music management system is performing digital content in the two or more zones.

A music management system according to the present disclosure may be a dedicated system for storing, sorting and performing digital music or other suitable content. The present disclosure is specifically directed to digital music, it is understood that the methods and apparatus of the present disclosure may also be adapted for use with video content, interactive game content, still image content, combined content and any other suitable digital content.

A music management system according to the present disclosure may include a touch screen as the primary interface and user control. All necessary functions will be completely operable via the touch screen. Any case where keyboard input is necessary such as naming a playlist, the system will present an on-screen keyboard display for input.

Designed from the ground up to be simple to use without any prior training. The music management system will generally eliminate any complexities from the user and present a consistent, easy to understand display and interface. The software of the music management system will run on any suitable computer operating system.

A music management system according to the present disclosure, may include a method of performing digital music with a single digital processor having the steps of: performing a first digital music item at a selected volume using a first set of speakers, selecting one of the plurality of digital music items for preview during the performance of the first digital music item, initiating a preview of the selected digital music item during the performance of the first digital music item, the preview having the steps of, diminishing the volume of the first digital music item over a first preselected time to a preselected volume, initiating a performance of a preselected portion of the selected digital music item by raising the volume of the preselected portion over a second preselected time to the selected volume, performing for a third preselected time the first digital music item at the preselected volume and the preselected portion of the selected digital music at the selected volume, diminishing the volume of the preselected portion of the selected digital music over a fourth preselected time to no volume, and restoring the volume of the performance of the first digital music item to the selected volume over a fifth preselected time.

### BRIEF DESCRIPTION OF THE DRAWINGS

FIG. 1 is a block diagram of a music management system according to the present disclosure.

FIG. 2 is a block diagram of the software architecture of the music management system of FIG. 1.

FIG. 3 is a timing diagram of the preview feature of the music management system of FIG. 1.

FIG. 4 is a timing diagram of a cross fade performed by the music management system of FIG. 1.

FIG. 5 is a timing diagram of a cross fade performed with the preview feature of the music management system of FIG. 1.

FIG. 6 is a high level flow chart for insertion of digital media into the music management system of FIG. 1.

FIG. 7 is a flow chart for ripping a CD using the music management system of FIG. 1.

FIG. 8 is a flow chart for gathering ID data for a ripped CD using the music management system of FIG. 1.

FIG. 9 is a flow chart for manual entry of digital media information using the music management system of FIG. 1.

### DETAILED DESCRIPTION OF THE INVENTIONS

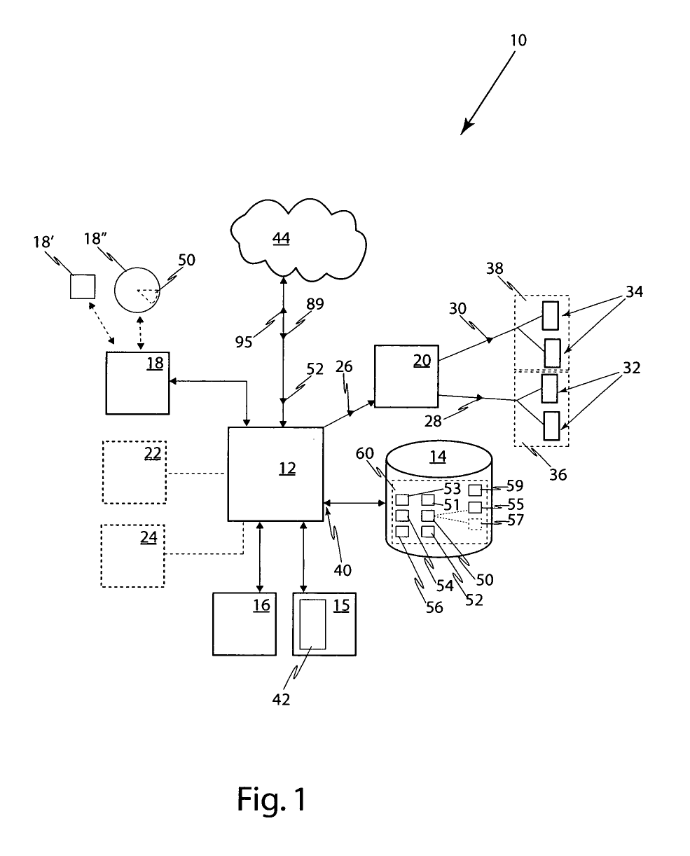

Referring to FIG. 1, music management system 10 includes processor 12, hard drive 14, system storage 15, display 16, external media interface 18, and output interface 20. Additionally, music management system 10 may also include one or more optional pointing devices and or data entry elements such as pointing device 22 and an optional external control device 24. Processor 12 may be any suitable computer processor, a currently preferred processor is a Pentium® 4 Celeron® processor. (Pentium® & Celeron® are registered trademarks of Intel Inc.)

Output interface 20 may be any suitable device generally recognized as a sound card for converting digital signals 26 to analog signals such as output signals 28 and 30. Output signals such as output signals 28 and 30 may be applied to any suitable conversion devices such as speakers 32 and 34 respectively. Speakers 32 may be located in a location separate from speakers 34. Each set of speakers such as speakers 32 and speakers 34 may form separate performance zones such as performance zones 36 and 38 respectively. Output interface 20 may produce a line level output suitable for amplification using any conventional amplifier, preamp, or amplified speakers.

External media interface 18 may be any suitable digital media reader such as a CD or DVD reader or read/writer, or any digital card reader/writer, or floppy drive. External media interface 18 is format or codec agnostic able to support any suitable digital media format. Any suitable digital external media such as digital media 18′ and 18″ may be used to import digital content such as digital content item 50 into music management system 10. Digital content such as digital music 52 may also be downloaded or otherwise imported into music management system 10 across any network such as internet 44. Upon importation of digital content into music management system 10, imported digital content is stored in system database 60 in hard drive 14.

Processor 12 may also include one or more I/O ports such as storage interface 40 to permit connection of one or more suitable storage elements such as hard drive 14. Hard drive 14 provides storage for digital content items such as digital content item 42.

Music management system software 42 may be stored in any suitable storage element such as system storage 15, or hard drive 14. System storage 15 may be any suitable device such as a flash media card. The use of a flash media card for storage of system software 42 may provide some security to prevent unauthorized copying and modification of system software 42. System software 42 is currently configured to launch upon application of power to, and initiation of powerup of music management system 10.

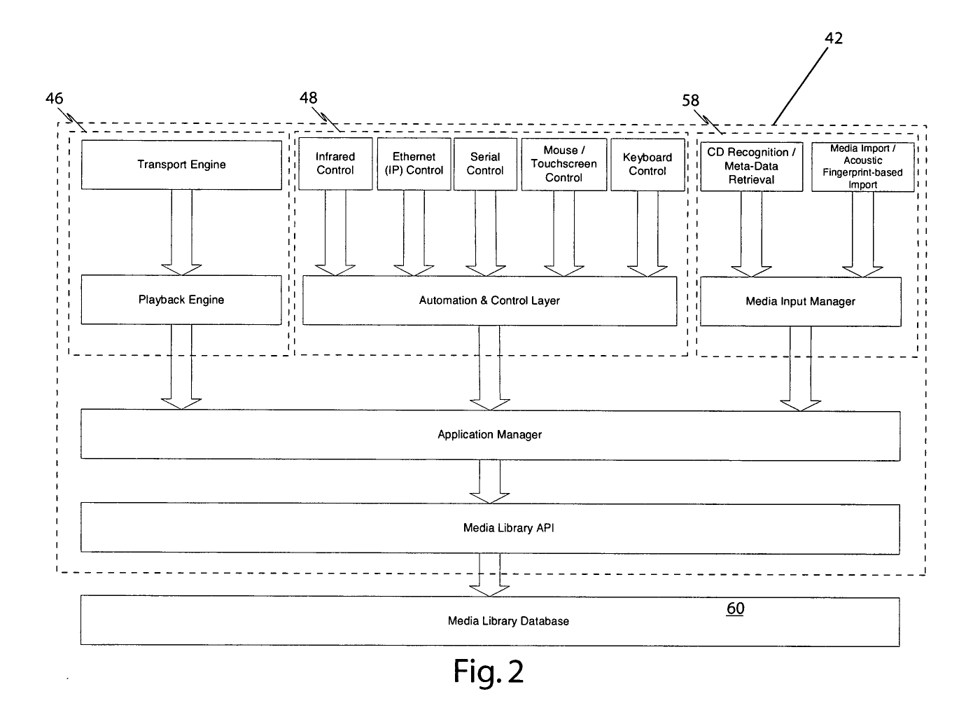

Referring now to FIG. 2, system software 42 may include three or more primary components as independent modules such as playback module 46, control module 48, and media import module 58. As currently configured, playback module 46 is independent allowing playback of digital media to be unaffected by actions occurring in other modules.

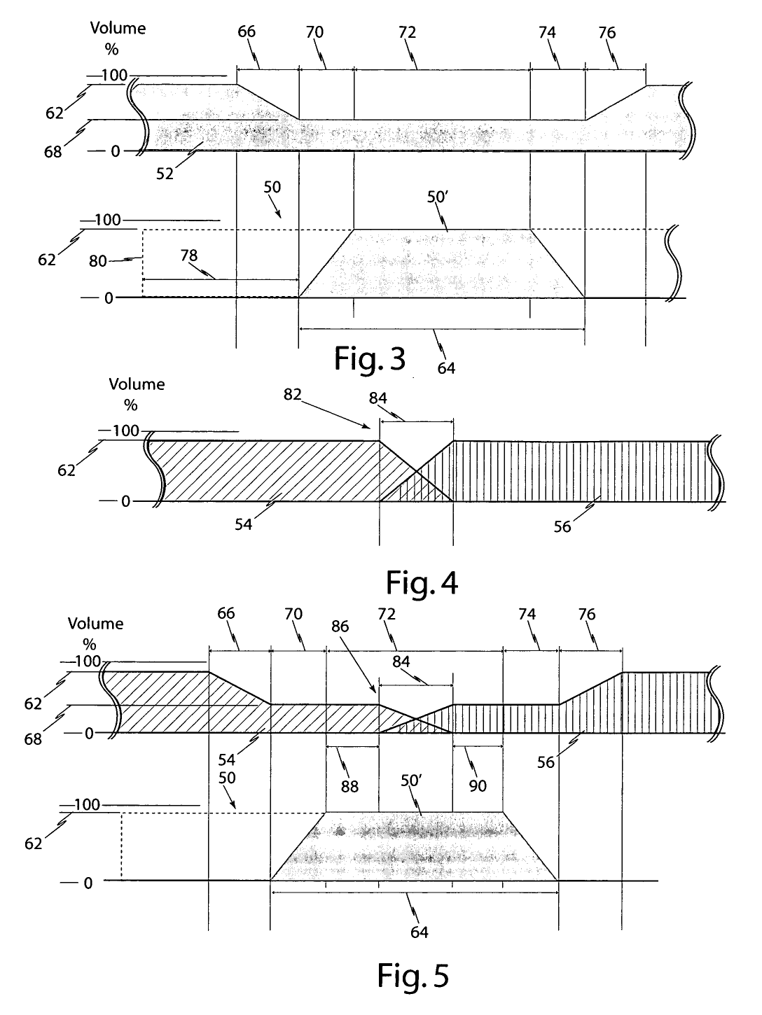

Referring now to FIG. 3, music management system 10 may permit a preview of a selected digital content item such as digital content item 50 while a first digital content item such as digital music 52 is being performed. Digital content such as digital music 52 may be performed at any volume level between 0 and 100% such as selected volume level 62. Once a user has selected a digital content item for preview such as digital content item 50, the user may initiate the preview using any suitable technique such as double clicking on the selected digital content item or double tapping in the case of a touch screen interface. On initiation of a preview, system software 42 identifies preview portion 50′ of digital content item 50 to be performed during preview period 64. Preview portion 50′ may selected to begin after period 78 from beginning 80 of digital music 52.

During time period 66, system software 42 lowers the volume of digital music 52 from selected volume level 62 to background volume 68. In time period 70, playback module 46 raises the performance volume of digital content item 50 from zero to selected volume level 62. During preview play period 72, digital music 52 is being performed at background volume 68 simultaneously preview portion 50′ of digital content item 50 is being performed at selected volume level 62. At the completion of preview play period 72, during time period 74 the volume of digital content item 50 is lowered to zero. Upon completion of time period 74, during time period 76 the volume of digital music 52 is restored to selected volume level 62.

Time periods 66, and 70 and background volume 68 may be selected by a user and stored by system software 42. System software 42 may also review digital content in system database 60 and identify representative portions of digital content for use during preview. Representative portions such as preview portion 50′ may be selected based on audio spectral analysis or any other suitable technique.

Selected volume level 62 may be determined as a percentage of the total volume 68 of a particular digital content item. In another configuration, selected volume level 62 may be a percentage of a normalized volume 63 that is determined by system software 42 for each digital content item in system database 60.

Referring now to FIG. 4, timing of crossfade 82 performed by music management system 10 is illustrated using digital content item 54 being performed by music management system 10 at selected volume level 62 in performance zone 36. Music queue 51 is contained within system database 60 and lists digital content to be performed in performance zone 36. Digital content item 56 is listed in music queue 51 as following digital content item 54. At time period 84 before the conclusion of digital content item 54, system software 42 begins decreasing the performance volume of digital content item 54 from selected volume level 62 to zero. Simultaneously, system software 42 increases the volume of the digital content item listed as following the currently playing item from music queue 51, here, digital content item 56. System software 42 increases the volume of digital content item 56 from zero to selected volume level 62 during time period 84.

Referring now to FIG. 5 system software 42 of music management system 10 may also perform a preview of a portion of a selected digital content item such as preview portion 50′ of digital content item 50 while simultaneously performing a crossfade such as crossfade 86. Crossfade 86 may occur at any time during preview period 64. Crossfade time period 84 as well as preview period 64 may be preselected by a user, time periods 88 and 90 may be determined by system software 42 using known time periods 64, 70, 72, 74, and 84.

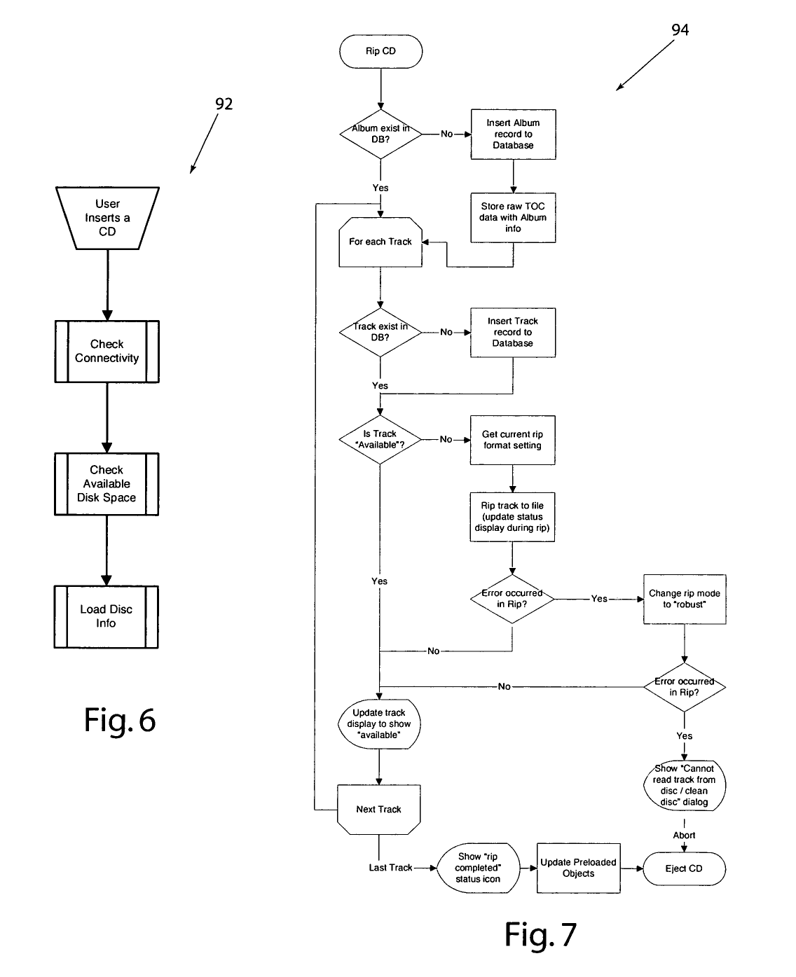

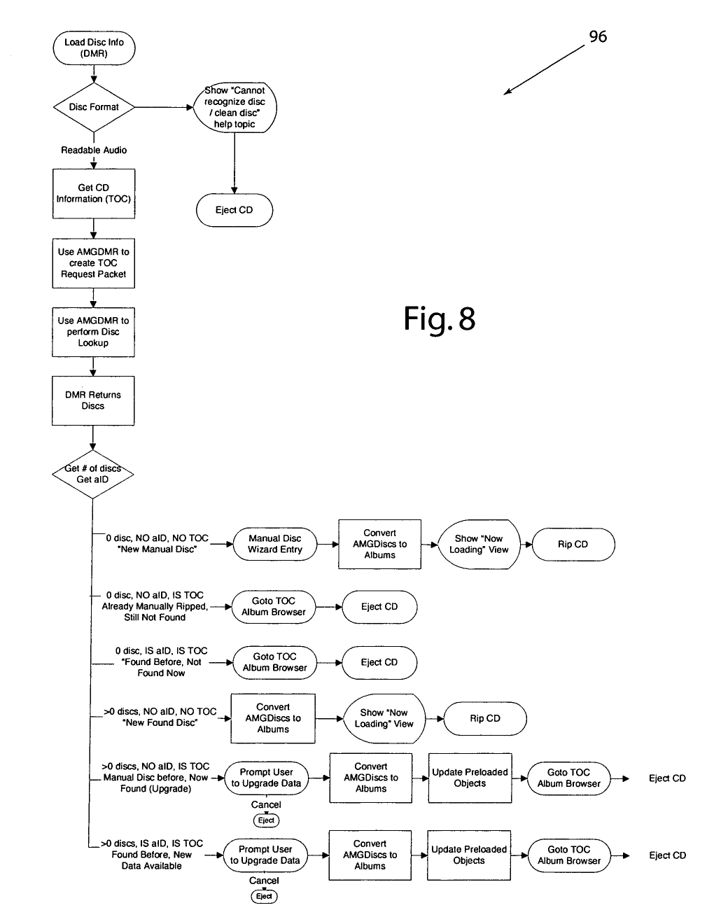

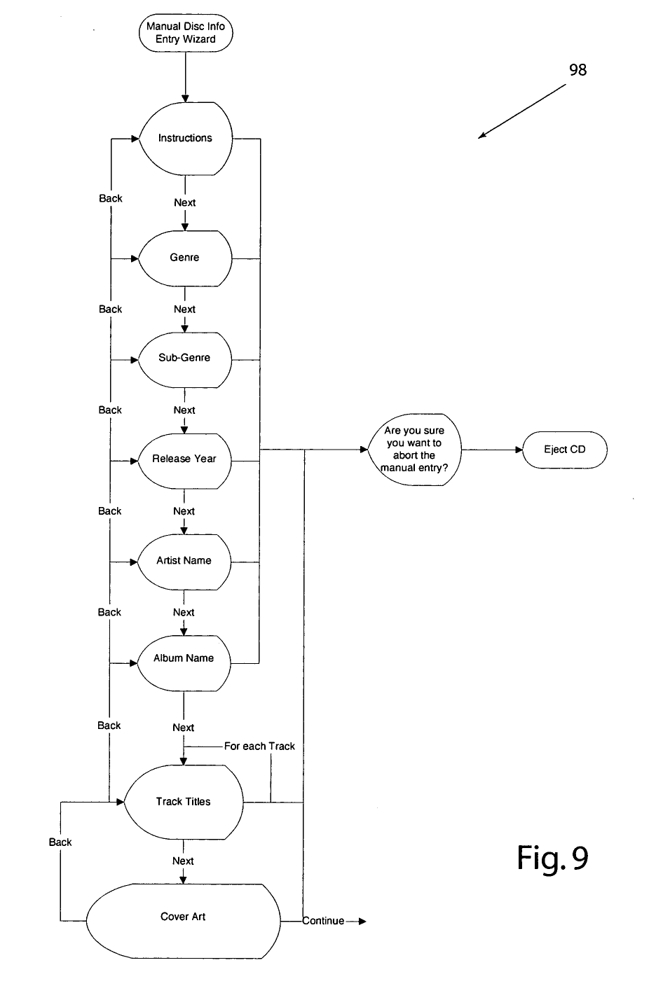

Referring now to FIGS. 1, 6, 7, 8, and 9, content loading process 92 is designed to load musical content from standard, commercial Compact Discs, or any other suitable storage media onto hard disk 14 of music management system 10.

Using external media interface 18, music management system 10 reads digital information such as digital content item 50 from a CD such as digital media 18″, encodes it into one of several possible formats such as formats available in Windows Media Audio format (WMA) and then stores it on hard disk 14.

During media information gathering process 96, system software 42 may also retrieves the CD's Table of Contents (TOC) information such as TOC 95 that may include details such as the exact frame offset of each track on the disc, the total duration of the disc, and the frame offset to the first track. This TOC information may then be provided to a suitable 3^{rd} party who would provide relevant meta data such as meta data 89. Music management system 10 as currently configures provides TOC information to All Media Guide (AMG) and TOC 95 is sent to AMG's servers for recognition. If a match is found from their database, meta-data 55 for the CD is returned and stored in system database 60. If a match is not found, the user is prompted, through a wizard interface, to enter the information manually and that data is then stored in system database 60 as user-submitted data 57. User-submitted data 57 may also be uploaded to a 3^{rd} party such as AMG, for future use including improvement of the lookup technology and supplementing the master AMG database.

Loading process 92 begins when the user inserts a CD into the CD tray of external media interface 18. Music management system 10 will then automatically spin up the CD and attempt to determine the exact type of CD that has been inserted.

If the disc is determined to contain audio tracks such as red book or orange book formatting, then the system will proceed with the loading sequence. If not, the disc is checked to see if it is YELLOW BOOK. If the disc is YELLOW BOOK, it is a standard data CD and is checked to see if it is a software Update CD for system software 42. If the CD is none of the above formats, then a message may be shown to the user indicating that this is a CD of a type that is not supported by the system and the CD or other digital media may be ejected.

Next, music management system 10 will check to see if there is adequate disk space on hard disk 14 to store the digital content. Adequate space is determined by assuming that the digital content such as a CD is 600 MB in size and by maintaining a buffer such as buffer 59 of 1 GB for miscellaneous storage on the hard disk. Therefore, if there is less than 1.6 GB of remaining space, a message will be shown to the user indicating that there is not enough space remaining to load the CD and it is ejected.

In order to access the AMG data service, music management system 10 must be able to reach the AMG servers via Internet 44 or other suitable network. The system will attempt to call the AMG API's initialize function at this time, thus testing a) the network connection completely including verification that the internal network card is functioning, b) that the system has a valid IP configuration information, that the IP stack is loaded and functioning, c) that the unit is connected in some way to the Internet (via router or direct connection, etc) and d) that the AMG servers accessible. If this entire path is not successful, then a message will be shown to the user indicating that there is an issue with their network configuration and they will be given an opportunity to retry the network setup or cancel. If they attempt to retry the network setup, the application will return them to the network configuration screen. If they choose to cancel, the CD will be ejected.

Music management system 10 will now read the TOC from the CD that was inserted and call the supplied AMG or other supplied API function to lookup the CD. The API call will then return zero or more records containing information about the CD. If the API returns zero records, the user will then be presented with a message indicating that there were no matches found for the CD they inserted and they can choose to manually enter the data using process 98 or skip loading the CD (by ejecting the CD).

If the API returns exactly one record, the system will then display that CD on the screen for the user to confirm. The display will include the data described in the “Basic CD Data Display” section below.

If the API returns more than one record, music management system 10 will then evaluate the data field returned with each record that indicates the “confidence factor” (a value on the scale from 1 to 10) associated with that match of the data. The AMG service supplies this data to assist in determining what order the CDs should be displayed to the user in based on likelihood that this is the correct match. System software 42 checks to see if there is a record with a confidence factor of 10. If there is a record with confidence factor of 10, the information from that record is shown in the “Basic CD Data Display” style to the user with a message indicating that this was the “best match for your CD”. The user can then choose to confirm that this is the correct disc and begin loading, or they can choose to review other possible matches. If they choose to review other possible matches, these are then displayed using a next and previous pager system and the same Basic CD Data Display to allow the user to browse the other possible matches. At any point in this process, they can select one of these choices as the correct match and begin loading using that meta-data, or they can choose to abort the automatic matching process and go to the Manual CD Data Entry Wizard.

If there is no record of confidence level 10 in the provided matches, the system will proceed directly to the paging system, allowing the user to browse the available matches and the matches are presented in reverse order of confidence, highest confidence factors first.

Next, the system will begin to load the audio data from the CD onto the system's hard disk. The raw audio data for each track is read from the CD and, using the Microsoft Windows Media Format SDK or any other suitable format, the data is stored on hard disk 14 in WMA format. Files are named using a Globally Unique Identifier (GUID) as the filename. For example, digital content item 50 may be assigned filename 1b507066-d4c0-4662-9f78-3cbe501b25ee.wma and all meta-data for the album and for each track is stored in database 60. While the CD is being loaded, the system will display the Basic CD Data Display in the main window with a title of “loading cd” above it. In addition, the system will show a progress meter at the top of the screen to indicate what percentage of the CD is loaded so far and what percentage of the current track is loaded so far.

While the CD is loading, the user can continue all other operations of the system as normal while the CD continues to load in the background. The user can return to the Basic CD Data Display view at any time to check the loading progress in detail by clicking on the round progress meter at the top of the screen.

When CDs cannot be automatically found using the provided selection process, system software 42 may allow the user to enter the necessary data manually using process 98. A sequence of steps organized as a wizard is provided to aid in this process. The wizard consists of a sequence of steps and during each step, display 16 may include includes a previous and next button (if applicable), a cancel button (allowing the user to abort the process entirely), and a help window (that displays HTML-formatted text designed to provide the user with instructions on how to best complete this step).

Intro—First, the user is shown a simple page containing help text that describes the fact that the CD that they inserted could not be found in the database and therefore, meta-data could not be retrieved. The text describes that the user can now use the provided wizard to enter the data manually.

Genre—Next, the user is asked to specify the Genre that this CD applies to. An on-screen keyboard is supplied so that the user may type in the Genre using the touch screen provided with the Q100 unit. The database on the Q100 is shipped pre-loaded with all genres used in the AMG service database. As the user types, any genres that are already in the system that begin with the already typed characters are shown, providing the user with a filtered list that “auto-completes” as they type. They can, at any time in this step, choose an item from the list, thus eliminating the need to type the entire genre name, or continue typing to manually enter either one from the list or an entirely new genre name not previously found in the database. When they are satisfied with their genre selection, they can press Next to proceed to the next step.

Style—Next, the user is asked to specify the Style that this CD applies to. The style is an additional meta-data element supplied by the AMG service that identifies the type of music more specifically than genre. Each genre has many subordinate styles. As with genre, the user can use the on-screen keyboard to type in the style they wish to assign. As the user types, any styles that are already in the system that begin with the already typed characters are shown, providing the user with a filtered list that “auto-completes” as they type. They can, at any time in this step, choose an item from the list, thus eliminating the need to type the entire style name, or continue typing to manually enter either one from the list or an entirely new style name not previously found in the database. When they are satisfied with their style selection, they can press Next to proceed to the next step.

Year—Next, the user is asked to specify the year that the CD was released. An on-screen numeric keypad is displayed, allowing the user to type in a four-digit year. When they are satisfied with their selection, they can press next to proceed to the next step.

Artist Name—Next, the user is asked to specify the Artist that is assigned to the CD. This represents the primary artist for that CD meaning the one that would be written on the spine of the CD. The user is presented with an on-screen keyboard and is able to type in an artist name. As with genre, as the user types, any artist names that start with the characters already typed will be displayed in a list below the entry area. The user can, at any time, select an item from the list or continue to type. When they are satisfied with their Artist Name selection, they can press Next to proceed to the next step.

Album Title—Next, the user is asked to specify the Album Title from their CD. The user is presented with an on-screen keyboard and is able to type in the Album Title from their CD. When they are satisfied with the Album Title entered, they can press Next to proceed to the next step.

Track Titles—Next, the user is shown a list of tracks found on their CD. Since the CD was not recognized automatically and no meta-data is available, the system will use the TOC information to display a list with the appropriate number of tracks. The track titles will be defaulted using the provided Album Title (from the previous step) and will be appended with the track number. For example: “Dark Side of the Moon—Track 3”. The user can then choose to edit any of the defaulted track title values. The user is presented with an on-screen keyboard, a textbox for entering the value for the currently selected track. The user can change which track title is being editing by either clicking the provided next/back buttons or by clicking on a track from the list box of tracks provided. Once the user is satisfied with the list of track titles they have modified, they can proceed to the next step. No actual changes are required on this step if the user does not wish to change the defaulted track titles provided by the system.

Cover Art—Next, the user is allowed to choose from one of several default cover art images. Again, since the system was unable to retrieve meta-data for this CD, there is no available album art and this selection is meant to serve as a stand-in replacement. The user will see a list box containing several system-provided cover art images and they can choose one by clicking on it. Once the user is satisfied with their selection of default cover art, they can proceed to the next step.

Preview—Finally, the finished CD data is shown in a “preview” format, shown in the “Basic CD Data Display” format. This allows the user to see the CD as it will be stored in the system for future use. If the user wishes to change any aspect of this data, they can choose to go back to any step in the above wizard and make the necessary changes.

Thus, while the preferred embodiments of the devices and methods have been described in reference to the environment in which they were developed, they are merely illustrative of the principles of the inventions. Other embodiments and configurations may be devised without departing from the spirit of the inventions and the scope of the appended claims.

1. A method of performing digital music with a single digital processor comprising the steps of:
performing a first digital music item at a selected volume using a first set of speakers;
selecting one of the plurality of digital music items for preview during the performance of the first digital music item;
initiating a preview of the selected digital music item during the performance of the first digital music item, the preview having the steps of;
diminishing the volume of the first digital music item over a first preselected time to a preselected volume;
initiating a performance of a preselected portion of the selected digital music item by raising the volume of the preselected portion over a second preselected time to the selected volume;
performing for a third preselected time the first digital music item at the preselected volume and the preselected portion of the selected digital music at the selected volume;
diminishing the volume of the preselected portion of the selected digital music over a fourth preselected time to no volume; and
restoring the volume of the performance of the first digital music item to the selected volume over a fifth preselected time.

2. The method of claim 1 further comprising:
confirming the selected digital music as a second digital music item for performance;
simultaneously diminishing the volume of the performance of the first digital music item over a preselected transition time to no volume; and
raising the volume of a performance of the second digital music item to the selected volume over the preselected transition time.

3. The method of claim 1 further comprising:
simultaneous with the preceding steps, performing an alternate digital music item at a second selected volume through a second set of speakers.

4. A method of performing digital content with a single digital processor comprising the steps of:
performing a first digital content item at a selected volume;
selecting one digital content item from the plurality of digital content items for preview during the performance of the first digital content item;
initiating a preview of the selected digital content item during the performance of the first digital content item, the preview having the steps of;
diminishing the volume of the first digital content item over a first preselected time to a preselected volume;
initiating a performance of a preselected portion of the selected digital content item by raising the volume of the preselected portion over a second preselected time to the selected volume;
performing for a first determinable period, the first digital content item at the preselected volume and the preselected portion of the selected digital content at the selected volume;
simultaneously diminishing the volume of the first digital content item to no volume and increasing the volume of a second digital content item to the preselected volume;
performing for a second determinable period, the second digital content item at the preselected volume and the preselected portion of the selected digital content at the selected volume;
diminishing the volume of the preselected portion of the selected digital content over a fourth preselected time to no volume; and
increasing the volume of the performance of the second digital content item to the selected volume over a fifth preselected time.
